(19) United States
(12) Patent Application Publication
(10) Pub. No.: US 2024/0186028 A1
(43) Pub. Date: Jun. 6, 2024

(54) TESTING AND EDUCATION MICROREACTOR

(71) Applicant: VIRGINIA TECH INTELLECTUAL PROPERTIES, INC., Blacksburg, VA (US)

(72) Inventor: Alireza HAGHIGHAT, Arlington, VA (US)

(21) Appl. No.: 18/549,440

(22) PCT Filed: Apr. 29, 2022
(86) PCT No.: PCT/US2022/027013

§ 371 Date: Sep. 7, 2023

Related U.S. Application Data
(60) Provisional application No. 63/181,392, filed on Apr. 29, 2021.

(51) Int. Cl. G21C 17/00; G09B 23/20; G21C 17/104; G21C 17/112

(52) U.S. Cl. CPC G21C 17/001; G21C 17/104; G21C 17/112; G09B 23/20

(57) ABSTRACT

A configurable microreactor for testing and education is described. The microreactor includes a reactor core comprising a plurality of fuel rods, a plurality of guide tubes, and a plurality of rotating control drums configured to control operation of the microreactor. Further, the microreactor includes a testing cavity disposed in an area within the reactor configured to store an item therein for experimentation; a plurality of beam ports; a moveable particle filter ring; a moveable spectrum shifter; and at least one sensor. A computing device is directed to receive measurements from the at least one sensor and perform a physics-based analysis of the microreactor using one or more machine learning (ML) routines.

### CROSS-REFERENCE TO RELATED APPLICATION

This application claims the benefit of and priority to U.S. Provisional Patent Application No. 63/181,392 filed Apr. 29, 2021 entitled “TESTING AND EDUCATION MICROREACTOR,” the contents of which being incorporated by reference in their entirety herein.

### BACKGROUND

Nuclear reactor includes various control mechanisms, such as control rods, control drums, and the like, and thus have highly complicated designs. The control mechanisms oversee reactivity of nuclear fuel and the nuclear reactor. As may be appreciated, performing simulations, experiments, and other analyses using a nuclear reactor is difficult or impossible due to design complexities, security concerns, and the like. Modeling, simulation, phenomenon-based testing, and so forth are performed outside of radiation environments encountered in real-life scenarios. As such, the modeling and simulations are purely theoretical, the modeling and simulations cannot be validated accurately, and uncertainties cannot be quantified. Existing reactors are designed for training commercial operators and performing a limited number of experimentations, which is not well suitable for validation of computational tool, investigation physics and chemistry of novel fuel mixtures and designs, and educational purposes.

### BRIEF SUMMARY

Various embodiments are disclosed for a robust, highly instrumented, and flexible testing and education microreactor that is capable of performing high-fidelity measurements for physics and chemistry testing, system monitoring and control, validation computational methods for modeling and simulation of nuclear systems, instrumentation and detection system development and calibration, and the like, thereby providing unique experimental capabilities in support of advanced reactor designs as well as nuclear science and engineering education and research.

In a first aspect, a microreactor for testing and education is described that includes: a reactor core comprising a plurality of fuel rods, a plurality of guide tubes, and a plurality of rotating control drums configured to control operation of the microreactor; a testing cavity disposed in an area within the reactor configured to store an item therein for experimentation; a plurality of beam ports; a moveable particle filter ring a moveable spectrum shifter; at least one sensor; at least one computing device comprising at least one hardware processor in communication with the at least one sensor; and program instructions stored in memory and executable in the at least one computing device that, when executed, direct the at least one computing device to receive measurements from the at least one sensor and perform an analysis of the microreactor based at least in part on the measurements.

In a second aspect, a method is described that includes providing a microreactor that is configurable for testing and education, the microreactor comprising: a reactor core comprising a plurality of fuel rods, a plurality of guide tubes, and a plurality of rotating control drums configured to control operation of the microreactor; a testing cavity disposed in an area within the reactor configured to store an item therein for experimentation; a plurality of beam ports; a moveable particle filter ring a moveable spectrum shifter; and at least one sensor. The method further includes receiving, by at least one computing device is communication with the at least one sensor, measurements from the at least one sensor, and performing, by the at least one computing device, an analysis of the microreactor based at least in part on the measurements.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a radial cross-section view of a microreactor according to various embodiments of the present disclosure.

FIG. 2 is a schematic diagram showing the microreactor in association with a computing environment according to various embodiments of the present disclosure.

FIG. 3 is a flowchart showing an example method according to various embodiments of the present disclosure.

### DETAILED DESCRIPTION

The embodiments described herein relate to a microreactor that provides an environment for testing issues associated with advanced reactors as well as for conducting research on various aspects of nuclear reactor systems, such as nuclear reactor modeling and simulation. Existing reactors for education were built in the late 1960s, mainly for training power plant operators. Today, due to the costs and complexities associated with use of a reactor, including a nuclear reactor, training and simulations are performed using computer-based simulations where an actual nuclear reactor is not present. There is limited training on physical reactors and, as such, an ability to understand physics of reactors is rather limited.

The embodiments for the microreactor described herein offer a robust, highly instrumented, flexible, and multi-purpose nuclear reactor design. As such, according to various embodiments, a microreactor for testing- and education-related tasks is described that may include a reactor core, a testing cavity, and testing tubes within the reactor core. The microreactor may include beam ports to provide various openings for taking measurements and the like.

Further, the microreactor may include rotating control drums positioned, for instance, at a periphery of the reactor core. The microreactor may include one or more moveable filter and spectrum shifter rings, as well as external moveable rings. In some embodiments, the fuel rods may be of differing enrichments, compositions, materials, and/or sizes depending on radial rings for example, and may be removable and/or rotatable to provide an effective use of fuel. In some embodiments, a subset of the fuel rods may be equipped for radial and azimuthal oscillations which yield neutron noise for reactivity analysis. All of the fuel rods may be monitored using one or more sensors, such as a fission density sensor, a temperature sensor, a dosimetry sensor, and so forth, axially through placement of guide tubes in between fuel rods, for example.

The testing cavity of the microreactor may be dimensioned and positioned such that minimal feedback is provided to the reactor core. In some embodiments, the testing cavity may include instrumented loops and containers for physics and chemistry-related testing of different fuels (e.g., tristructural-isotropic (TRISO) pebble, molten salt (MS), High-Assay Low-Enriched Uranium (HALEU), and so forth), and detection systems. The instrumented loops may allow for control of flow and temperature, as may be appreciated.

Accordingly, using the microreactor described herein, individuals have the ability to test advanced or new concepts for advanced reactors. Moreover, the microreactor may be used to train personnel and provide researchers, scientists, etc., with an ability to perform different types of tasks with the microreactor. Notably, the varying tasks can be done relative ease and without significant limitations. Additional components of the microreactor are to be described, followed by a discussion of operation of the same.

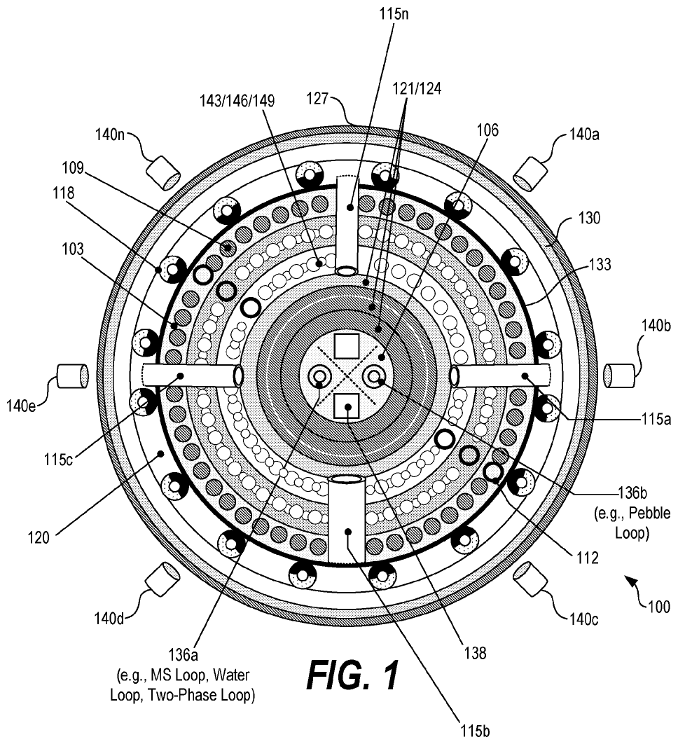

Turning now to the drawings, FIG. 1 shows a radial cross-section view of a microreactor 100 according to various embodiments of the present disclosure. The microreactor 100 may include a nuclear reactor according to various embodiments. The microreactor 100 may include a reactor core 103 and a testing cavity 106, as may be appreciated. The testing cavity 106 may also be referred to as a testing chamber, and may be isolated to the extent possible by isolation regions, as will be described, to avoid interference with experimentation performed therein.

The reactor core 103 may include, for example, fuel rods 109, guide tubes 112, and/or other components as well be described. The fuel rods 109, in various embodiments, may be rotatable fuel rods 109 of differing types. For instance, the rotatable fuel rods 109 may include a first type of rotatable fuel rod 109, a second type of rotatable fuel rod 109, a third type of rotatable fuel rod 109, and so forth. Differing types of fuel rods 109 may include fuel rods of different fuel mixtures, materials, sizes, enrichments (e.g., 3-5% enrichment up to 19.5% enrichment), compositions, and the like, as may be appreciated.

In various embodiments, the fuel rods 109 may include containers having fission products disposed therein providing support for pellets and/or providing heat removal. The fuel rods 109 may be formed of zirconium alloy or other suitable material. In some embodiments, the fuel rods 109 may be filled with helium or other gas to compensate for outside pressure. The fuel rods 109 may be disposed annularly relative to the testing cavity 106, for example. In some embodiments, the fuel rods 109 may be movable. For instance, in some embodiments, the fuel rods 109 may adjust vertically (e.g., up and down).

The reactor core 103 may further include testing tubes within the reactor core 103 and one or more beam ports 115a . . . 115n (collectively “beam ports 115” or “at least one beam port 115”) offering different openings. The testing beam portsmay permit various experiments to be performed during operation of the microreactor 100, as may be appreciated. Likewise, the beam ports 115 may be utilized to perform various experiments by providing an opening from an exterior of the microreactor 100 to a shifter or a filter disposed within the microreactor 100, as will be described. In some embodiments, the microreactor 100 includes first beam port 115a and second beam port 115c positioned in a horizontal direction and opposing sides of the microreactor 100 (e.g., at three o′ clock and nine o′ clock positions), and third beam port 115b and fourth beam port 115n in a vertical direction on opposing sides of the microreactor 100 (e.g., at noon and six o′ clock positions). The third beam port 115b and the fourth beam port 115n may be positioned perpendicular to the first beam port 115a and the second beam port 115c, respectively.

As such, various kinds of devices may be connected to the microreactor 100 for measurements and/or other tests. In some embodiments, the beam ports 115 of the microreactor 100 may be plugged with various shielding plugs or other suitable devices for shielding the beam ports 115. A first end of the beam ports 115 may terminate at or beyond the moveable materials annuli 127 in some embodiments, and a second end of the beam ports 115 may terminate at or near the isolation region(s) (e.g., moveable particle filter rings 121 and/or one or more moveable spectrum shifter rings 124), as will be described.

Further, the microreactor 100 may include one or more control drums 118 (or “at least one control drum 118”) that is configured to rotate on a periphery of the reactor core 103. In other words, one or more control drums 118 may be positioned around and annularly about a perimeter of the reactor core 103. The control drum 118 may provide rotary actuation and, to this end, control an overall reactivity of the microreactor 100. The control drum 118 may be positioned apart one another such that air 120 is disposed between individual ones of the control drums 118.

Each of the control drums 118 may include a reflector, fuel, absorber material, and/or other components not described herein. Further, in various embodiments, each of the control drums 118 may have one side formed of a control material and a second opposing side formed of a defector material. By rotating the control drums 118, for example, the microreactor 100 can be started or stopped. In some embodiments, controls (not shown) of the control drums 118 may be positioned outside of the reactor core 103 to avoid interference with various measurements made in the reactor core 103 or overall operation of the microreactor 100.

The microreactor 100 may further include one or more isolation regions. Specifically, in some embodiments, the microreactor 100 includes one or more moveable particle filter rings 121 and/or one or more moveable spectrum shifter rings 124 (collectively “isolation regions”). The isolation regions may be configured to prevent the testing cavity 106 providing feedback to the reactor core 103. As such, the isolation regions (e.g., the particle filter rings 121 and/or the spectrum shifter rings 124) may be formed up of lead, steel, stainless steel, concrete, carbon, other suitable materials, and/or a combination thereof. In some embodiments, the particle filter rings 121 and/or the moveable spectrum shifter rings 124 may be formed up of or include neutron inhibiting materials, gamma inhibiting materials, or a combination thereof. Neutron inhibiting materials may include materials disposed with or otherwise containing boron additives, lithium additives, and the like. The spectrum shifter rings 124, for example, may provide spectral shift based on neutron spectrum shifting from a resonance energy region at a beginning of a cycle to a thermal region at an end of the cycle.

A moveable materials annulus 127 may be positioned outside the reactor core 103 and the rotating control drum 118. In various embodiments, the moveable materials annuli 127 may emulate reactor dosimetry. As such, in some embodiments, the moveable materials annuli 127 may be adjusted in coordination with fuel rods 109. The microreactor 100 may further include a vessel 130 disposed within and adjacent to the moveable materials annuli 127. The microreactor 100 may include a core barrel 133 disposed within the moveable materials annuli 127 where the reactor core 103 is disposed within the core barrel 133.

In some embodiments, the filter rings 121, 124 may include a neutron absorbing layer adjacent to another metal layer so that neutron absorbing and metal layers alternate through a side wall disposed around the testing cavity 106. As such, the filter rings 121, 124 may be described as having a neutron absorbing layer (or layers) configured to absorb neutrons radiated from the testing cavity or radiated from radioactive nuclear waste and metal layers configured to absorb gamma particles radiated from the testing cavity and/or radioactive nuclear waste as well as radiated from the neutron absorbing layer or layers that result from absorption of neutron particles. Although not limited to these specific materials, in some embodiments, metal layers may include carbon steel and a neutron absorbing layer may include a polymer material, cementitious material, a metallic material, or combination thereof. Furthermore, in any of the embodiments, the steel filters can be differing steel materials, and the neutron absorbing filters can be different neutron absorbing materials. The microreactor 100 may further include external moveable rings.

In various embodiments, the fuel rods 109 may include fuel rods 109 of differing enrichments and/or sizes depending on, for example, radial rings, and may be rotatable for effective use of fuel. In some embodiments, all or a portion of the fuel rods 109 may be configured for radial and azimuthal oscillations which can yield neutron noise for reactivity analysis. All or a portion of the fuel rods 109 may be monitored axially by placement of the guide tubes 112 in between fuel rods 109. For instance, fission density, temperature, dosimetry, and the like may be monitored via the guide tubes 112.

The testing cavity 106 may be configured for minimal feedback to the reactor core 103. Further, the testing cavity 106 may include, for example, instrumented loops 136 and containers 138 for physics and chemistry testing of differing fuels and detection systems. Differing fuels may include, for example, tristructural-isotropic pebbles, molten salt, and the like. The loops 136 may include a molten salt (MS) loop, a two-phase loop, a pebble loop, other desired loop, and/or a combination thereof. The loops 136 may permit control of flow and temperature, as may be appreciated. The containers 138 may include various detectors, sensors, materials, and other items stored therein in association with an experiment or test.

In some embodiments, the microreactor 100 includes or is otherwise used in a system in association with a multi-modal detectors system having a multitude of sensors 140a . . . 140n (collectively “sensors 140” or “at least one sensor 140”) including, but not limited to, the CHANDLER multi-modal detectors system described in T. Subedi et al., “Reactor Antineutrino Detection Using CHANDLER: A New Portable Neutrino Detector,” Vol. 341, The 20th International Workshop on Neutrinos (NuFACT2018)-Poster Sessions, https://doi.org/10.22323/1.341.0059 (Dec. 12, 2019). It is understood that additional sensors may be disposed within the reactor core 103 and/or other parts of the microreactor 100. Further, in various embodiments, the microreactor 100 may include movable rotating rods 143, miniature fission chambers (FCs) 146, dosimeters 149, and so forth. For instance, various detectors (e.g., dosimeters 149) may be aligned with rods 143 and/or miniature FCs 146 to generate measurements associated therewith. In some embodiments, the detectors (e.g., electrical field sensors) may be positioned axially relative to a rod 143 to closely monitor fuel as the fuel burns. The miniature FCs 146 may include a small trace of uranium or other fuel.

In various embodiments, the microreactor 100 may utilize advanced in-situ detection and physics-based machine learning (ML) computation for real-time control and operation of the reactor. This capability will be employed in the testing cavity for control of experiments, inference of physics and chemistry parameters, and control of radiation field within the cavity. Finally, AM and immersive visualization will be utilized in the manufacturing and operation of the microreactor 100.

The microreactor 100 is a flexible design that may be coupled with advanced in-situ detection systems to create experimental environments suitable for evaluation of nuclear fuel of different types. The nuclear fuel thus may include flowing molten salt, TRISO pebbles, solid fuel of different types and enrichments, a combination hereof, and so forth. Accordingly, the microreactor 100 described herein may be utilized for development and evaluation of detection systems, and validation of modeling and simulation algorithms and tools. An advanced in-situ detection system may include computing and advanced detection performed using one or more machine learning routines to determine and set system parameters and configurations. For instance, machine learning routines may be executed to determine optimal movement of particle filters or spectrum shifters, optimal control rod rotation, and so forth, in a relatively short period of time. Further, the microreactor 100 may maintain that reactor safety limits and ensure that predefined technical specifications are satisfied and met. Currently, existing system adjustment and experimental setups require months of tedious and laborious work that is performed based on a combination of limited calculations, measurements, experience, and large conservative safety margins.

Accordingly, a microreactor 100 is described that may include rotating control drums 118 positioned, for instance, at a periphery of the reactor core 103. Additionally, the microreactor 100 may include moveable filter and spectrum shifter rings 121, 124, and external moveable rings. In some embodiments, the fuel rods 109 may be of differing enrichments and/or size depending on radial rings, and may be rotatable for effective use of fuel. In some embodiments, a subset of the fuel rods 109 may be equipped for radial and azimuthal oscillations which yield neutron noise for reactivity analysis. All of the fuel rods 109 may be monitored using at least one sensor, such as a fission density sensor, a temperature sensor, a dosimetry sensor, and so forth, axially trough placement of guide tubes 112 in between fuel rods 109.

The testing cavity 106 of the microreactor 100 may be dimensioned and positioned such that minimal feedback is provided to the reactor core 103. In some embodiments, the testing cavity 106 may include instrumented loops 136 and/or containers 138 for physics and chemistry testing of different fuels (e.g., TRISO pebble, molten salt, HALEU), and/or detection systems disposed therein. The instrumented loops 136 may allow for control of flow and temperature, as may be appreciated.

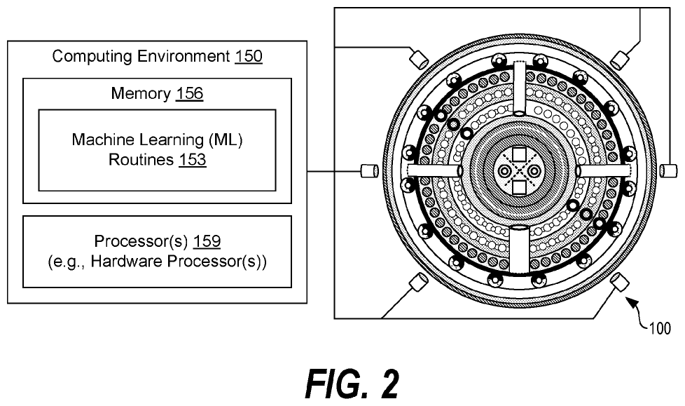

Turning now to FIG. 2, a schematic diagram is shown having the microreactor 100 described above in communication with a computing environment 150. The computing environment 150 may include, for example, a server computer, a desktop computer, or any other system providing computing capability. Alternatively, the computing environment 150 may employ a plurality of computing devices that may be arranged, for example, in one or more server banks or computer banks or other arrangements. Such computing devices may be located in a single installation or may be distributed among many different geographical locations. For example, the computing environment 150 may include a plurality of computing devices that together may comprise a hosted computing resource, a grid computing resource and/or any other distributed computing arrangement.

The microreactor 100 may utilize advanced in-situ detection and physics-based machine learning routines 153 that are stored in memory 156 and executable by a processor 159 (e.g., at least one hardware processor) for real-time control and operation of the microreactor 100. The microreactor 100 may be communicatively coupled to the computing environment 150, and/or the multi-modal detectors system having a multitude of sensors 140a. The machine learning routines 153 may be executed for control of experiments in the testing cavity 106, inference of physics and chemistry parameters, determination of reactor control parameters, and control of radiation field within the testing cavity 106. Finally, additive manufacturing (AM) and immersive visualization may be utilized in the manufacturing and operation of the microreactor 100. The measurements generated and the machine learning parameters as determined or optimized may be accessed by a client device or a terminal device, whether remote or locally.

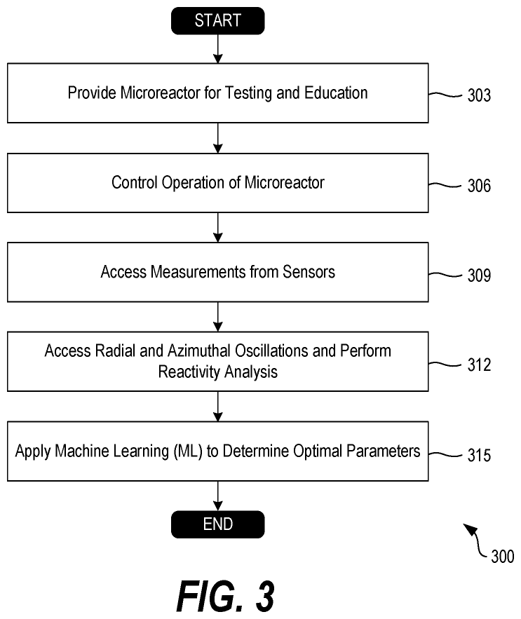

Referring next to FIG. 3, shown is a flowchart 300 that provides one example of the operation of a portion of the microreactor 100 according to various embodiments. It is understood that the flowchart of FIG. 3 provides merely an example of the many different types of functional arrangements that may be employed to implement the operation of the portion of the microreactor 100 or a control application thereof as described herein.

Accordingly, in box 303, a testing and education microreactor 100 may be provided that includes, for example, a reactor core 103 that includes a multitude of fuel rods 109 and a multitude of guide tubes 112; a testing cavity 106; at least one testing tube within the reactor core 103; a multitude of beam ports 115; a multitude of rotating control drums 118; a moveable filter ring 121; a spectrum shifter ring 124; a multitude of external moveable rings; at least one sensor; at least one computing device (e.g., computing environment 150) comprising at least one hardware processor; and program instructions stored in memory and executable in the at least one computing device that, when executed, direct the at least one computing device to receive measurements from the at least one sensor and perform an analysis of the testing and education microreactor 100 based at least in part on the measurements.

A number of the beam ports 115 as provided may be four or other suitable number. The rotating control drum 118 may be one of a multitude of rotating control drums 118 positioned at a periphery of the reactor core 103. The fuel rods 109 may be rotatable in various embodiments. The reactor core 103 may include differing types of the fuel rods 109 and differing types of the guide tubes 112. For instance, the differing types of rotatable fuel rods 109 may include fuel rods of differing enrichments, compositions, materials, and/or sizes.

In box 306, operation of the microreactor 100 may be controlled (e.g., by the control drums 118) to start or stop the microreactor 100, for example. In box 309, measurements from sensors 140 (and/or other sensors within the microreactor 100) may be accessed or otherwise collected. The at least one sensor may include one configured to detect radial and azimuthal oscillations generated by a portion or a subset of the fuel rods 109. As such, in box 312, the at least one computing device may be further directed to receive the radial and azimuthal oscillations from at least one sensor and perform reactivity analysis based at least in part on the radial and azimuthal oscillations.

In some embodiments, the at least one sensor is at least one fuel rod sensor configured to measure a fission density of at least one of the plurality of fuel rods 109. The at least one fuel rod sensor may thus be configured to measure a temperature of at least one of the plurality of fuel rods 109, and/or at least one fuel rod sensor configured to measure a dosimetry of at least one of the plurality of fuel rods 109. The at least one fuel rod sensor may be monitored axially through placement of the guide tubes 112 in between the plurality of fuel rods 109, for example.

Again, the testing cavity 106 may be dimensioned to provide minimal feedback to the reactor core. Further, the testing cavity 106 may include instrumented loops 136 and containers 138 for physics and chemistry testing of at least one type of fuel. The at least one type of fuel may be one of tri-structural isotropic particle fuel, TRISO pebble fuel, molten salt, and HALEU among others. The instrumented loops 136 may permit control of flow and temperature, as may be appreciated.

At box 312, the computing environment (e.g., at least one computing device) may be directed to execute at least one machine learning routine 153 in association with real-time control and operation of the microreactor 100. The at least one machine learning routine may be at least one physics-based machine learning routine 153, for example. The at least one machine learning routine 153 may be employed in association with in-situ detection of the testing cavity for control of experiments, inference of physics and chemistry parameters, and/or control of a radiation field within the testing cavity, among others. The microreactor 100 as provided may further include an annulus 127 formed of a moveable material to emulate reactor dosimetry, the annuli 127 being adjustable in coordination with the plurality of fuel rods 109. The at least one sensor may be a multitude of sensors 140 part of a multi-modal detector system in some embodiments.

The embodiments can be embodied or implemented in hardware, software, or a combination of hardware and software. If implemented in hardware, the embodiments can include at least one processing circuit, with at least one storage or memory device. The at least one processing circuit can include, for example, one or more processors and one or more storage or memory devices coupled to a local interface. The local interface can include, for example, a data bus with an accompanying address/control bus or any other suitable bus structure. The storage or memory device can store data or components that are executable by the processors of the processing circuit.

In another example, if implemented in hardware, the embodiments can include as a circuit or state machine that employs any suitable hardware technology. The hardware technology can include, for example, one or more microprocessors, discrete logic circuits having logic gates for implementing various logic functions upon an application of one or more data signals, application specific integrated circuits (ASICs) having appropriate logic gates, and/or programmable logic devices (e.g., field-programmable gate array (FPGAs), and complex programmable logic devices (CPLDs)).

If implemented in software, each step or element can represent a module or group of code that includes program instructions to implement the specified logical function(s). The program instructions can be embodied in the form of, for example, source code that includes human-readable statements written in a programming language or machine code that includes machine instructions recognizable by a suitable execution system, such as a processor in a computer system or other system.

Also, one or more of the components described herein that include software or program instructions can be embodied in any non-transitory computer-readable medium for use by or in connection with an instruction execution system such as, a processor in a computer system or other system. The computer-readable medium can contain, store, and/or maintain the software or program instructions for use by or in connection with the instruction execution system.

A computer-readable medium can include a physical media, such as, magnetic, optical, semiconductor, and/or other suitable media. Examples of a suitable computer-readable media include, but are not limited to, solid-state drives, magnetic drives, or flash memory. Further, any logic or component described herein can be implemented and structured in a variety of ways. For example, one or more components described can be implemented as modules or components of a single application. Further, one or more components described herein can be executed in one computing device or by using multiple computing devices.

Further, any logic or applications described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices. Additionally, terms such as “application,” “service,” “system,” “engine,” “module,” and so on can be used interchangeably and are not intended to be limiting.

Clause 1. A microreactor for testing and education, comprising: a reactor core comprising a plurality of fuel rods, a plurality of guide tubes, and a plurality of rotating control drums configured to control operation of the microreactor; a testing cavity disposed in an area within the reactor configured to store an item therein for experimentation; a plurality of beam ports; a moveable particle filter ring; a moveable spectrum shifter; at least one sensor; at least one computing device comprising at least one hardware processor in communication with the at least one sensor; and, program instructions stored in memory and executable in the at least one computing device that, when executed, direct the at least one computing device to receive measurements from the at least one sensor and perform an analysis of the microreactor based at least in part on the measurements.

Clause 2. The microreactor for testing and education according to clause 1, wherein the plurality of beam ports comprises a first one of the beam ports, a second one of the beam ports, a third one of the beam ports, and a fourth one of the beam ports.

Clause 3. The microreactor for testing and education according to any of clauses 1-2, wherein: the first beam port and the second beam port are positioned horizontally on opposing sides of the microreactor; the third beam port and the fourth beam port are positioned vertically on opposing sides of the microreactor; and the third beam port and the fourth beam port are positioned perpendicular to the first beam port and the second beam port, respectively.

Clause 4. The microreactor for testing and education according to any of clauses 1-3, wherein the rotating control drum is one of a plurality of rotating control drums positioned at a periphery of the reactor core.

Clause 5. The microreactor for testing and education according to any of clauses 1-4, wherein the reactor core comprises differing types of the plurality of fuel rods and differing types of guide tubes.

Clause 6. The microreactor for testing and education according to any of clauses 1-5, wherein the differing types of rotatable fuel rods comprise fuel rods of differing enrichments, compositions, materials, and sizes.

Clause 7. The microreactor for testing and education according to any of clauses 1-6, wherein the at least one sensor is configured to detect radial and azimuthal oscillations generated by a subset of the plurality of fuel rods.

Clause 8. The microreactor for testing and education according to any of clauses 1-7, wherein the at least one computing device is further directed to receive the radial and azimuthal oscillations from at least one sensor and perform reactivity analysis based at least in part on the radial and azimuthal oscillations.

Clause 9. The microreactor for testing and education according to any of clauses 1-8, wherein the at least one sensor is at least one fuel rod sensor configured to perform at least one of: measuring a fission density of at least one of the plurality of fuel rods; measuring a temperature of the at least one of the plurality of fuel rods; and/or measuring a dosimetry of at least one of the plurality of fuel rods.

Clause 10. The microreactor for testing and education according to any of clauses 1-9, wherein the at least one fuel rod sensor is monitored axially through placement of the plurality of guide tubes in between the plurality of fuel rods.

Clause 11. The microreactor for testing and education according to any of clauses 1-10 wherein: the testing cavity is dimensioned and positioned to provide minimal feedback to the reactor core; and the testing cavity comprises instrumented loops and containers for physics and chemistry testing of at least one type of fuel.

Clause 12. The microreactor for testing and education according to any of clauses 1-11, wherein the at least one type of fuel is one of tri-structural isotropic (TRISO) particle fuel; TRISO pebble fuel; molten salt (MS); and High-Assay Low-Enriched Uranium (HALEU).

Clause 13. The microreactor for testing and education according to any of clauses 1-12, wherein the at least one computing device is further directed to execute at least one machine learning routine in association with real-time control and operation of the testing and education microreactor.

Clause 14. The microreactor for testing and education according to any of clauses 1-13, wherein the at least one machine learning routine is employed in association with in-situ detection of the testing cavity for control of experiments, inference of physics and chemistry parameters, and control of a radiation field within the testing cavity.

Clause 15. The microreactor for testing and education according to any of clauses 1-14, further comprising an annulus formed of a moveable material to emulate reactor dosimetry, the annuli being adjustable in coordination with the plurality of fuel rods.

Clause 16. The microreactor for testing and education according to any of clauses 1-15, wherein the at least one sensor is a plurality of sensors part of a CHANDLER-type multi-modal detector system.

Clause 17. A method, comprising: providing a microreactor that is configurable for testing and education, the microreactor comprising: a reactor core comprising a plurality of fuel rods, a plurality of guide tubes, and a plurality of rotating control drums configured to control operation of the microreactor; a testing cavity disposed in an area within the reactor configured to store an item therein for experimentation; a plurality of beam ports; a moveable particle filter ring a moveable spectrum shifter; and at least one sensor; receiving, by at least one computing device is communication with the at least one sensor, measurements from the at least one sensor; and performing, by the at least one computing device, an analysis of the microreactor based at least in part on the measurements.

Clause 18. The method according to clause 17, further comprising executing, by the at least one computing device, at least one machine learning routine in association with real-time control and operation of the microreactor.

Clause 19. The method according to any of clauses 17-18, wherein the at least one machine learning routine is employed in association with in-situ detection of the testing cavity for control of experiments, inference of physics and chemistry parameters, and control of a radiation field within the testing cavity.

Clause 20. The method according to any of clauses 17-19, wherein the testing cavity comprises instrumented loops and containers for physics and chemistry testing of at least one type of fuel and the at least one type of fuel is one of tri-structural isotropic (TRISO) particle fuel; TRISO pebble fuel; molten salt (MS), and High-Assay Low-Enriched Uranium (HALEU).

Therefore, the following is claimed:

1. A microreactor for testing and education, comprising:
a reactor core comprising a plurality of fuel rods, a plurality of guide tubes, and a plurality of rotating control drums configured to control operation of the microreactor;
a testing cavity disposed in an area within the reactor configured to store an item therein for experimentation;
a plurality of beam ports;
a moveable particle filter ring and a moveable spectrum shifter;
at least one sensor;
at least one computing device comprising at least one hardware processor in communication with the at least one sensor; and
program instructions stored in memory and executable in the at least one computing device that, when executed, direct the at least one computing device to receive measurements from the at least one sensor and perform an analysis of the microreactor based at least in part on the measurements.

2. The microreactor for testing and education according to claim 1, wherein the plurality of beam ports comprises a first one of the beam ports, a second one of the beam ports, a third one of the beam ports, and a fourth one of the beam ports.

3. The microreactor for testing and education according to claim 2, wherein:
the first beam port and the second beam port are positioned horizontally on opposing sides of the microreactor;
the third beam port and the fourth beam port are positioned vertically on opposing sides of the microreactor; and
the third beam port and the fourth beam port are positioned perpendicular to the first beam port and the second beam port, respectively.

4. The microreactor for testing and education according to claim 1, wherein the rotating control drum is one of a plurality of rotating control drums positioned at a periphery of the reactor core.

5. The microreactor for testing and education according to claim 1, wherein the reactor core comprises differing types of the plurality of fuel rods and differing types of guide tubes.

6. The microreactor for testing and education according to claim 5, wherein the differing types of rotatable fuel rods comprise fuel rods of differing enrichments, compositions, materials, and sizes.

7. The microreactor for testing and education according to claim 1, wherein the at least one sensor is configured to detect radial and azimuthal oscillations generated by a subset of the plurality of fuel rods.

8. The microreactor for testing and education according to claim 1, wherein the at least one computing device is further directed to receive the radial and azimuthal oscillations from at least one sensor and perform reactivity analysis based at least in part on the radial and azimuthal oscillations.

9. The microreactor for testing and education according to claim 1, wherein the at least one sensor is at least one fuel rod sensor configured to perform at least one of:
measuring a fission density of at least one of the plurality of fuel rods;
measuring a temperature of the at least one of the plurality of fuel rods; and
measuring a dosimetry of at least one of the plurality of fuel rods.

10. The microreactor for testing and education according to claim 9, wherein the at least one fuel rod sensor is monitored axially through placement of the plurality of guide tubes in between the plurality of fuel rods.

11. The microreactor for testing and education according to claim 1, wherein:
the testing cavity is dimensioned and positioned to provide minimal feedback to the reactor core; and
the testing cavity comprises instrumented loops and containers for physics and chemistry testing of at least one type of fuel.

12. The microreactor for testing and education according to claim 11, wherein the at least one type of fuel is one of tri-structural isotropic (TRISO) particle fuel; TRISO pebble fuel; molten salt (MS); and High-Assay Low-Enriched Uranium (HALEU).

13. The microreactor for testing and education according to claim 1, wherein the at least one computing device is further directed to execute at least one machine learning routine in association with real-time control and operation of the testing and education microreactor.

14. The microreactor for testing and education according to claim 13, wherein the at least one machine learning routine is employed in association with in-situ detection of the testing cavity for control of experiments, inference of physics and chemistry parameters, and control of a radiation field within the testing cavity.

15. The microreactor for testing and education according to claim 1, further comprising an annulus formed of a moveable material to emulate reactor dosimetry, the annuli being adjustable in coordination with the plurality of fuel rods.

16. The microreactor for testing and education according to claim 1, wherein the at least one sensor is a plurality of sensors part of a CHANDLER-type multi-modal detector system.

17. A method, comprising:
providing a microreactor that is configurable for testing and education, the microreactor comprising:
a reactor core comprising a plurality of fuel rods, a plurality of guide tubes, and a plurality of rotating control drums configured to control operation of the microreactor;
a testing cavity disposed in an area within the reactor configured to store an item therein for experimentation;
a plurality of beam ports;
a moveable particle filter ring and a moveable spectrum shifter; and
at least one sensor;
receiving, by at least one computing device is communication with the at least one sensor, measurements from the at least one sensor; and
performing, by the at least one computing device, an analysis of the microreactor based at least in part on the measurements.

18. The method according to claim 17, further comprising executing, by the at least one computing device, at least one machine learning routine in association with real-time control and operation of the microreactor.

19. The method according to claim 18, wherein the at least one machine learning routine is employed in association with in-situ detection of the testing cavity for control of experiments, inference of physics and chemistry parameters, and control of a radiation field within the testing cavity.

20. The method according to claim 18, wherein the testing cavity comprises instrumented loops and containers for physics and chemistry testing of at least one type of fuel and the at least one type of fuel is one of tri-structural isotropic (TRISO) particle fuel; TRISO pebble fuel; molten salt (MS); and High-Assay Low-Enriched Uranium (HALEU).
